(19) United States
(12) Patent Application Publication
(10) Pub. No.: US 2016/0124489 A1
(43) Pub. Date: May 5, 2016

(54) DISPLAY APPARATUS AND DISPLAY METHOD

(71) Applicant: SAMSUNG ELECTRONICS CO., LTD., Suwon-si (KR)

(72) Inventor: Jin-sung KANG, Hwaseong-si (KR)

(73) Assignee: SAMSUNG ELECTRONICS CO., LTD., Suwon-si (KR)

(21) Appl. No.: 14/854,470

(22) Filed: Sep. 15, 2015

(30) Foreign Application Priority Data
Oct. 30, 2014 (KR) 10-2014-0149014

(51) Int. Cl. G06F 1/32; G09G 3/20

(52) U.S. Cl. CPC G06F 1/3265; G09G 3/2092; G06F 1/3287; G09G 2330/021

(57) ABSTRACT

A display apparatus is provided, which includes a receiver configured to receive video data, a signal processor configured to process the received video data, an outputter configured to output the processed video data, a generator configured to generate power using heat that is discharged from the display apparatus, a charger configured to store the generated power, and a controller configured to control supplying of the stored power to constituent elements of the display apparatus in the case where or when the display apparatus is in a standby power mode.

### CROSS-REFERENCE TO RELATED APPLICATIONS

This application claims priority under 35 U.S.C. §119(a) to Korean Patent Application No. 10-2014-0149014, filed on Oct. 30, 2014, in the Korean Intellectual Property Office, the disclosure of which is incorporated herein by reference.

### BACKGROUND

1. Field

The present disclosure relates generally to an electronic technology, and more particularly to a display apparatus and a display method, which can generate and consume power by itself.

2. Description of the Related Art

CRT (Cathode-Ray Tube) was first invented in the late nineteenth century, and has been widely used in the field of a display device, such as a TV or a computer monitor for more than 100 years. However, due to the technical characteristic of the CRT that uses the principle in which a fluorescent material produces light when electrons that are emitted from an electron gun hit a glass surface on which the fluorescent material is coated, it has the disadvantage of having a large volume. Accordingly, a flat panel display (FPD) technology that can greatly reduce the thickness of a display device has appeared.

A flat panel display is classified into an LCD (Liquid Crystal Display) using liquid crystals, a PDP (Plasma Display Panel) using gas discharge having the same principle as the principle of neon sign, an OLED (Organic Light Emitting Diode) display made of an organic material which is a fluorescent organic compound having a light emission phenomenon that the fluorescent organic compound emits light if current flows thereto, an FED (Field Emission Display), an ELD (Electro Luminescence Display), and the like.

In such a flat panel display technology, various schemes for reducing power consumption have been proposed, However, as the size of a display panel is increased and the resolution thereof is heightened, the power reduction schemes proposed up to now have limitations in efficiently using the power and greatly reducing the power consumption. Accordingly, there is a need for an epoch-making scheme that can greatly reduce the power consumption of the display device.

### SUMMARY

The present disclosure has been made to address at least the above needs and to provide at least the advantages described below, and an aspect of the present disclosure is to provide a display apparatus which can greatly reduce power consumption of a display apparatus.

According to one aspect of the present disclosure, a display apparatus includes a receiver configured to receive video data; a signal processor configured to process the received video data; an outputter configured to output the processed video data; a generator configured to generate a power using heat that is discharged from the display apparatus; a charger configured to be charged by and store the generated power; and a controller configured to control supplying of the charged power to constituent elements of the display apparatus in the case where the display apparatus is in a standby power mode.

The controller may operate to supply the charged power to the constituent elements of the display apparatus if or when the power charged or stored in the charger is equal to or higher than a predetermined value in the case where the display apparatus is in the standby power mode.

The controller may operate to supply the charged power to a RTC (Real Time Clock) unit if or when the power charged in the charger is equal to or higher than the predetermined value in the case where the display apparatus is in the standby power mode.

The controller may operate to supply the charged power to at least one of the receiver, the signal processor, and the outputter if or when the power charged in the charger is equal to or higher than a predetermined value in the case where the display apparatus is in the standby power mode.

The display apparatus may enter into the standby power mode if or when a predetermined time elapses in a state where the video data is not input.

The display apparatus may enter into the standby power mode if or when a predetermined control signal is received from a remote control device.

The controller may control a Switched Mode Power Supply (SMPS) unit to supply the power to the constituent elements of the display apparatus if or when the power charged in the charger is lower than a predetermined value in the case where the display apparatus is in the standby power mode.

The signal processor may include at least one of an Audio/Video (A/V decoder, a scaler, a frame rate converter, and a video enhancer, the outputter may include a timing controller, and the controller may operate to supply the charged power to at least one of the A/V decoder, the scaler, the frame rate converter, the video enhancer, and the timing controller in the case where the display apparatus is in the standby power mode.

The generator may include a thermoelectric generator.

According to another aspect of the present disclosure, a display method includes receiving video data; processing the received video data; outputting the processed video data; generating a power using heat that is discharged from a display apparatus; charging the generated power; and supplying the charged power to constituent elements of the display apparatus in the case where the display apparatus is in a standby power mode.

The supplying the charged or stored power may supply the charged power to the constituent elements of the display apparatus or when the charged power is equal to or higher than a predetermined value in the case where the display apparatus is in the standby power mode.

The supplying the charged or stored power may supply the charged power to a RTC (Real Time Clock) unit or when the charged power is equal to or higher than the predetermined value in the case where the display apparatus is in the standby power mode.

The supplying the charged or stored power may supply the charged power to at least one of a receiver, a signal processor, and an outputter or when the charged power is equal to or higher than a predetermined value in the case where the display apparatus is in the standby power mode.

The display apparatus may enter into the standby power mode or when a predetermined time elapses in a state where the video data is not input.

The display apparatus may enter into the standby power mode or when a predetermined control signal is received from a remote control device.

The display method may further include a main power unit supplying the power to the constituent elements of the display apparatus or when the charged power is lower than a predetermined value in the case where the display apparatus is in the standby power mode.

The supplying the power may supply the power to at least one of an A/V decoder, a scaler, a frame rate converter, a video enhancer, and a timing controller in the case where the display apparatus is in the standby power mode.

The generating the power may generate the power using a thermoelectric generator.

According to one aspect of the present disclosure, a display apparatus includes a display element that produces heat, a converter configured to convert the heat to electricity, a storage configured to store the electricity, and a controller configured to power the display element with electricity from the storage when the display element is in a standby state. The converter may include a thermocouple.

According to another aspect of the present disclosure, a display method includes producing heat by a display element, generating electricity using the heat, storing the electricity, and supplying stored electricity to the element when the display element is in a standby state. The generating may use a thermocouple.

As described above, according to various embodiments of the present disclosure, the display technology that can greatly reduce the power consumption can be provided.

### BRIEF DESCRIPTION OF THE DRAWINGS

The above and other aspects, features and advantages of the present disclosure will be more apparent from the following detailed description when taken in conjunction with the accompanying drawings, in which:

FIG. 1 is a block diagram illustrating the configuration of a display apparatus according to an embodiment of the present disclosure;

FIGS. 2A and 2B are diagrams explaining the principle of thermoelectric generation and thermoelectric cooling by a thermoelectric device;

FIG. 3 is a diagram illustrating the configuration of a thermoelectric module;

FIG. 4 is a block diagram illustrating the configuration of a display apparatus according to another embodiment of the present disclosure; and

FIG. 5 is a flowchart of a display method according to an embodiment of the present disclosure.

### DETAILED DESCRIPTION OF THE PREFERRED EMBODIMENTS

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

The terms “first”, “second”, etc. may be used to describe diverse components, but the components are not limited by the terms. The terms are only used to distinguish one component from the others.

The terms used in the present application are only used to describe the exemplary embodiments, but are not intended to limit the scope of the disclosure. The singular expression also includes the plural meaning as long as it does not differently mean in the context. In the present application, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiment of the present disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown).

Hereinafter, the present disclosure will be described in detail with reference to the accompanying drawings.

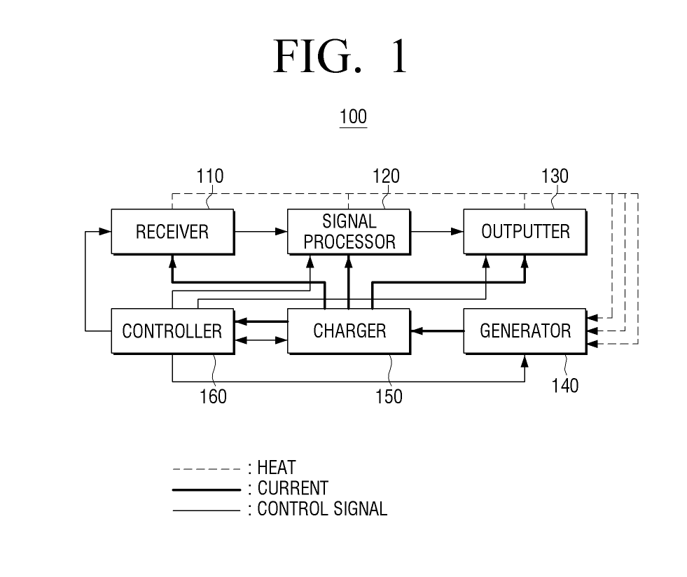

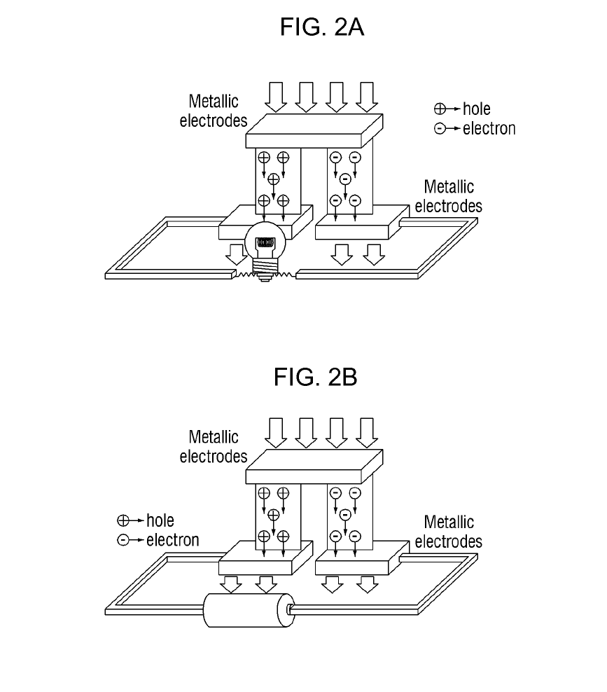

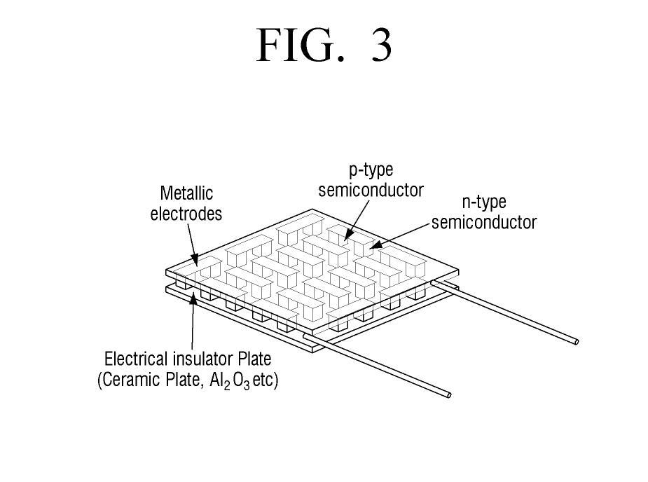

FIG. 1 is a block diagram illustrating the configuration of a display apparatus according to an embodiment of the present disclosure. FIGS. 2A and 2B are diagrams explaining the principle of thermoelectric generation and thermoelectric cooling by a thermoelectric device, and FIG. 3 is a diagram illustrating the configuration of a thermoelectric module.

Display apparatuses 100-1 and 100-2, according to various embodiments of the present disclosure to be described hereinafter, can be implemented by various electronic devices. That is, each of the display apparatuses 100-1 and 100-2, according to various embodiments of the present disclosure, is an apparatus which includes one or more displays, and is configured to execute applications or to display content. For example, the display apparatus may be implemented by any one of a digital TV, a tablet, a personal computer (PC), a portable multimedia player (PMP), a personal digital assistant (PDA), a smart phone, a cellular phone, a digital photo frame, a digital signage, and a kiosk. Further, the technical idea of the present disclosure may also be applied to electronic devices having no display.

Referring to FIG. 1, the display apparatus 100-1 according to an embodiment of the present disclosure includes a receiver 110, a signal processor 120, an outputter 130, a generator 140, a charger or storage 150, and a controller 160.

The receiver 110 is a constituent element that receives video data and information related to the video data from an external device. The receiver 110 may receive broadcasting program content from a broadcasting station using a broadcasting network and receive content from a web server using the Internet. Further, the receiver 110 may receive content which is provided in the display apparatus 100-1 or is provided from various kinds of recording medium reproduction device connected thereto. Here, the recording medium reproduction device means a device that reproduces content that is stored in various types of recording media, such as, a CD, a DVD, a hard disc, a Blu-ray disc, a memory card, and a USB memory.

In the case of receiving content from a broadcasting station, the receiver 110 may include constituent elements, such as a tuner (not illustrated) and a demodulator (not illustrated).

The tuner selects an RF broadcasting signal that corresponds to a selected channel among RF broadcasting signals received through an antenna, and converts the selected RF broadcasting signal into an IF signal, a baseband image, or an audio signal. If the selected RF broadcasting signal is a digital broadcasting signal, the tuner converts the digital broadcasting signal into a digital IF signal, whereas if the selected RF broadcasting signal is an analog broadcasting signal, the tuner converts the analog broadcasting signal into an analog baseband image or an audio signal (CVBS SIF). The signal output from the tuner is input to the signal processor 120 to be described later. The tuner can receive an RF broadcasting signal of a single carrier according to an ATSC (Advanced Television System Committee) type or a plurality of carrier RF broadcasting signals according to a DVB (Digital Video Broadcasting) type.

The demodulator (not illustrated) receives and demodulates the digital IF signal that is output from the tuner. When or in the case where the digital IF signal that is output from the tuner is of an ATSC type, the demodulator performs 8-VSB (8-Vestigal Side Band) demodulation. When or in the case where the digital IF signal that is output from the tuner is of a DVB type, the demodulator performs CODSM (Coded Orthogonal Frequency Division Modulation) demodulation. Further, the demodulator may perform channel decoding, such as trellis decoding, deinterleaving, and Reed-Solomon decoding.

In the case of performing channel decoding, a stream signal TS is output. The stream signal may be a signal in which a video signal, an audio signal, and a data signal are multiplexed. For example, the stream signal may be an MPEG-2 TS in which a video signal of the MPEG-2 standard and an audio signal of the Dolby AC-3 standard are multiplexed. The stream signal that is output from the demodulator is input to the signal processor 120.

Unlike this, the receiver 110 may receive content from an external server, such as a web server. In this case, the receiver 110 may be implemented by a network interface card (not illustrated). In this case, the display apparatus 100-1 and the web server may follow TCP/IP that is the standard protocol for information transmission in the Internet. The TCP is a protocol for a technology to divide transmitted data in a predetermined unit and to pack the divided data, and the IP is a protocol for a technology to directly send and receive data.

The receiver 110 may receive content from various external devices in addition to the Internet. For this, the receiver 110 may include a CVBS (Composite Video Banking Sync) terminal, a component terminal, an S-video terminal (analog), a DVI (Digital Visual Interface) terminal, an HDMI (High Definition Multimedia Interface) terminal, an MHL (Mobile High-Definition Link) terminal, an RGB terminal, a D-SUB terminal, an IEE1394 terminal, an SPDIF terminal, a liquid HD terminal, and a USB terminal.

Further, the receiver 110 may include various wireless communication modules. For example, the receiver 110 may include near field communication modules, such as a WIFI module, a Bluetooth module, an IrDA (Infrared Data Association) module, an NFC (Near Field Communication) module, a Zigbee module, an RFID (Radio Frequency Identification) module, an IrDa (Infrared Data association) module, and a UWB (Ultra Wideband) module. Further, the receiver 110 may be implemented by the third-generation mobile communication module, such as a WCDMA (Wideband CDMA), a HSDPA (High Speed Downlink Packet Access), a HSUPA (High Speed Uplink Packet Access), or an HSPA (High Speed Packet Access), the fourth-generation mobile communication module, such a mobile WiMAX or WiBro, or the fourth-generation LTE (Long Term Evolution) module.

In addition, the receiver 110 may receive content from a set-top box. The set-top box may support bidirectional communication so as to support an IP TV.

The receiver 110 may include at least one of the various technical constituent elements as described above, and receive content from a plurality of different modules. The signal processor 120 to be described later processes the content received from the respective modules.

The signal processor 120 is a constituent element that processes the received video data. That is, the signal processor 120 divides the stream signal TS into audio and video data to match the aspect ratio of an image in which an object is displayed. Further, the signal processor 120 removes image deterioration or noise, sets a frame rate, and controls a video frame. The signal processor 120 transfers the video frame to the outputter 130.

The outputter 130 outputs the processed video data. That is, the outputter 130 receives a clock signal DCLK, a horizontal sync signal Hsync, and a vertical sync signal Vsync, generates a gate control signal (scanning control signal) and a data control signal (data signal), and rearranges RGB data of the video frame to output the rearranged RGB data to a display panel.

The generator 140 generates power using heat that is discharged from or produced by the display apparatus 100-1. Specifically, the generator 140 may generate the power using heat that is discharged from at least one of the receiver 110, the signal processor 120, and the outputter 130. For this, the generator 140 may include a thermoelectric generator.

The principle of the thermoelectric generator is as follows. If or when there is a temperature difference (ΔT=Th−Tc) between both ends of a material, in the case of an n-type semiconductor, electrons (in the case of a p-type semiconductor, positive holes) that exist on a high-temperature side are in a state where the electrons have energy that is higher than Fermi energy on average, and thus the electrons are diffused to a low-temperature side to lower their energy. Accordingly, a low-temperature end is charged by (−), and a high-temperature end is charged by (+) to cause an electric potential difference Vs to occur between the both ends of the material. This is called the Seebeck effect.

As a reversible phenomenon to the Seebeck phenomenon, if electric circuits are provided at the both ends of the material to provide DC electricity thereto, in the case of the n-type semiconductor, electrons absorb heat from the low-temperature end and move to the high-temperature end. This is called the Peltier effect, which is the basic principle of thermoelectric cooling.

Thermoelectric generation is performed using a thermoelectric device in which a p-type thermoelectric material and an n-type thermoelectric material are bonded in “H” shape as shown in FIG. 2A. If an electrode bonding portion is maintained at high, in the n-type material, the electrons (−) of a high-temperature region move to a low-temperature region, and the electric potential on the high-temperature side is heightened. Further, in the p-type material, the positive holes (+) of the high-temperature region move to the low-temperature region, and thus the electric potential on the low-temperature side is heightened. Accordingly, an open voltage is generated between (p-n) devices to cause current to flow.

For the thermoelectric generation, a thermoelectric module as shown in FIG. 3 is configured by electrically connecting a plurality of (p-n) devices in series and thermally connecting the plurality of (p-n) devices in parallel, and the efficiency of the thermoelectric generation is in proportion to a temperature difference between the high-temperature end and the low-temperature end.

The thermoelectric generation has the advantages of power generation only by a temperature difference, simple structure with no moving portion, easy maintenance and long lifespan, and various available heat sources, such as ocean heat, ground heat, engine waste heat, and factory waste heat.

The charger or storage 150 is a constituent element that is charged by and stores the generated power. The charger 150 is charged by and stores a DC power that is generated by the generator 140. For this, the charger 150 may include a secondary battery. Here, the secondary battery may be a nickel battery, a cadmium battery, a nickel-cadmium battery, a nickel-hydrogen battery, a lithium-ion battery, or a lithium ion polymer battery. Further, the charger 150 may supply a power to respective constituent elements in the display apparatus 100-1.

The controller 160 is a constituent element that controls the overall operation of the display apparatus 100-1. Specifically, in the case where the display apparatus 100-1 is in a standby power mode, the controller 160 operates to supply the stored power to the constituent elements of the display apparatus 100-1.

The standby power mode means a mode in which a main power that is supplied to a part or the whole of the display apparatus 100-1 is intercepted and a standby power is supplied in the case where the display apparatus 100-1 is in a specific state. The display apparatus 100-1 may enter into the standby power mode in various states.

If the main power is intercepted due to separation of an outlet of the display apparatus 100-1 from the power, the controller 160 may perform control operation so that the display apparatus 100-1 enters into the standby power mode. In this case, the stored power may be supplied to the constituent elements of the display apparatus 100-1.

Further, the controller 160 may perform a control operation so that the display apparatus 100-1 enters into the standby power mode if a predetermined time elapses in a state where video data is not input through the receiver 110.

Further, the controller 160 may perform a control operation so that the display apparatus 100-1 enters into the standby power mode if or when a predetermined control signal is received from a remote control device. For example, if a control signal that corresponds to pressing of a predetermined button of the remote control device is received in the display apparatus 100-1, the controller 160 may perform control operation so that the display apparatus 100-1 enters into the standby power mode.

In the case where the display apparatus 100-1 is in the standby power mode as described above, the controller 160 may sense a power value (power level) or electricity that is has charged the charger 150 and been stored therein. In this case, if the power value that is charged or stored in the charger 150 is equal to or larger than a predetermined value, the controller 160 operates to supply the charged or stored power (electricity) to the constituent elements of the display apparatus 100-1.

In this case, various constituent elements, to which the power is supplied, may be provided in the display apparatus 100-1. The constituent element may be a detailed constituent element of the receiver 110, the signal processor 120, or the outputter 130 as described above, or may be an RTC (Real Time Clock) unit of the display apparatus 100-1.

The RTC unit is a clock that operates in the display apparatus 100-1, and is included in a main board as a part of a microchip. This microchip is normally separated from a microprocessor and other chips, and is generally called a CMOS. System setting values are stored in a very small memory on the CMOS, and include the current time that is stored by a real-time clock. The time value is composed of year, month, day, hour, minute, and second. If the power of the display apparatus 100-1 is turned on, a basic input/output system that is stored in a ROM, i.e., BIOS, reads a real-time clock and the current time from the memory in the chip.

The RTC unit may be connected to the Internet and may receive time information from the Internet server for management. In this case, the RTC unit maintains the current time information, and if the power is not supplied and the time information is lost, it has an initial value. In order to provide real-time broadcasting information, it is required to have the current time information, and thus a general smart TV maintains the current time information through the RTC unit. For such an operation of the RTC unit, the smart TV maintains standby power even in a state where the power is turned off.

As described above, if the power that is stored in the charger 150 is equal to or higher than a predetermined value in the case where or when the display apparatus 100-1 is in the standby power mode, the controller 160 operates to supply the stored power to the RTC unit of the display apparatus 100-1.

Further, if the power that is stored in the charger 150 is equal to or higher than the predetermined value in the case where the display apparatus 100-1 is in the standby power mode, the controller 160 operates to supply the stored power to at least one of the receiver 110, the signal processor 120, and the outputter 130.

The controller 160 includes hardware configurations, such as an MPU (Micro Processing Unit) or a CPU (Central Processing Unit), a cache memory, and a data bus, and software configurations of applications for specific purposes. Control commands for the respective constituent elements for the operation of the display apparatus 100-1 are read from the memory according to the system clock, and electrical signals are generated according to the read control commands to operate the constituent elements of the hardware.

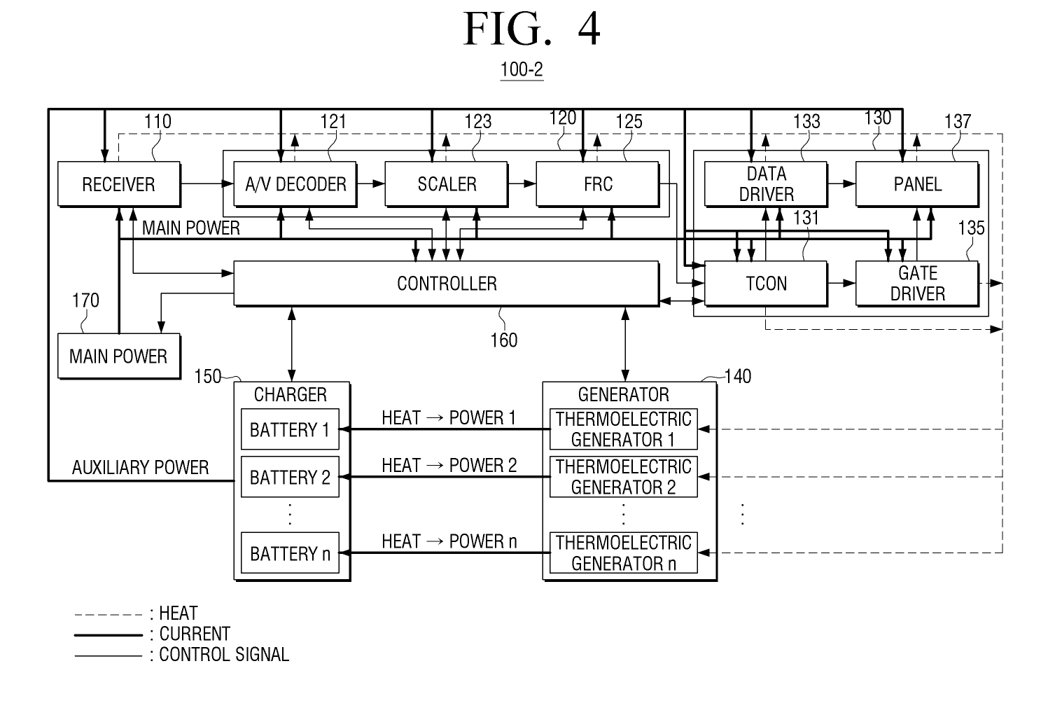

FIG. 4 is a block diagram illustrating the configuration of a display apparatus according to another embodiment of the present disclosure.

Referring to FIG. 4, a display apparatus 100-2 according to another embodiment of the present disclosure includes a receiver 110, a signal processor 120, an outputter 130, a generator 140, a charger 150, a controller 160, and a main power unit 170.

The configuration of the display apparatus 100-2 is the same as the configuration of the display apparatus 100-1 as described above except for the contents newly described below.

The signal processor 120 may include an A/V decoder 121, a scaler 123, and an FRC (Frame Rate Converter) 125.

If a stream signal is received, the A/V decoder 121 may demultiplex the stream signal to separate the stream signal into a video signal, an audio signal, and a data signal. The A/V decoder 121 performs decoding in the case where the demultiplexed video signal is an encoded video signal. For example, an encoded video signal of MPEG-2 standards may be decoded by an MPEG-2 decoder, and a video signal of H.264 standards, such as DMB (Digital Multimedia Broadcasting) or DVB-H, may be decoded by an H-264 decoder.

Further, the A/V decoder 121 may process a demultiplexed audio signal. For example, an encoded audio signal of MPEG-2 standards may be decoded by an MPEG-2 decoder, and an encoded audio signal of MPEG-4 BSAC (Bit Sliced Arithmetic Coding) standards of ground-wave DMB (Digital Multimedia Broadcasting) may be decoded by an MPEG-4 decoder. Further, an encoded audio signal of MPEG-2 AAC (Advanced Audio Codec) standards of a DMB type or a DVB-H type may be decoded by an AAC decoder.

In addition, the A/V decoder 121 may process a demultiplexed data signal. Encoded data may be decoded, and may include an EPG (Electric Program Guide) that indicates information on programs broadcast through respective channels. In the case of an ATSC type, the EPG may be TSC-PSIP (ATSC-Program and System Information Protocol) information, and in the case of a DVB type, the EGP may include DVB-SI (DVB-Service Information).

The scaler 123 controls an aspect ratio of a video frame to match the display panel. Further, when the operating system is booted, the scaler 123 switches respective wired interface modules, and sets time information of the display apparatus 100-2.

The FRC 125 converts the frame rate of a video frame of video data to match the purpose of display. For example, in the case of a single view mode, the FRC 125 may set the frame rate of the video frame of the video data to 60 Hz. Further, in the case of a multi-view mode, the FRC 125 may set the frame rate of the video frame of the video data to 120 Hz.

Further, although not illustrated in the drawing, the signal processor 120 may further include a video enhancer which removes image deterioration or noise and stores processed video data in a frame buffer. Further, the signal processor 120 may control at least one of brightness, contrast, resolution, sharpness, black tone, caption position and size, master volume, equalizer information (balance, amplification level per frequency band), and SRS TruSurround HD.

The outputter 130 may include a data driver 133, a timing controller 131, a gate driver 135, and a display panel 137. Further, if needed, the outputter 130 may further include a backlight.

The timing controller 131 receives an input of a clock signal DCLK, a horizontal sync signal Hsync, and a vertical sync signal Vsync, generates a gate control signal (scanning control signal) and a data control signal (data signal), and rearranges input RGB data to supply the rearranged RGB data to the data driver 133.

The timing controller 131 may generate a gate shift clock (GSC), a gate output enable signal (GOE), and a gate start pulse (GSP) in relation to the gate control signal as described above. The GSC is a signal for determining on/off time of thin film transistors (TFT) connected to light emitting diodes, such RGB organic light emitting diodes (OLEDs), and the GOE is a signal for controlling an output of the gate driver 135. The GSP is a signal for indicating the first driving line of a screen in one vertical sync signal.

Further, the timing controller 131 may generate a source sampling clock (SSC), a source output enable signal (SOE), and a source start pulse (SSP) in relation to the data control signal. The SSC is used as a sampling clock for latching data in the data driver 133, and determines the driving frequency of a data drive IC. The SOE is to transfer the data that is latched by the SSC to the display panel 137. The SSP is a signal for indicating data latch or sampling start in one horizontal sync period.

The gate driver 135 is a constituent element that generates a scanning signal, and is connected to the display panel 137 through scanning lines. The gate driver 135 applies a gate on/off voltage Vgh/Vgl that is provided from a voltage driver (not illustrated) to the display panel 137 in accordance with the gate control signal that is generated by the timing controller 131. The gate on voltage Vgh is successively provided from gate line 1 GL1 to gate line N GLn in order to implement a unit frame image on the display panel 137.

The data driver 133 is a constituent element that generates a data signal, and is connected to the display panel 137 through data lines. The data driver 133 inputs RGB data of a video image frame, of which the scaling is completed, to the display panel 137 in accordance with the data control signal that is generated by the timing controller 131. The data driver 133 converts the RGB vide data that is provided in series from the timing controller 131 into parallel data, converts digital data into an analog voltage, and provides video data that corresponds to one horizontal line to the display panel 137. These processes are successively performed per horizontal line.

Although not illustrated in the drawing, the outputter 130 further includes a voltage driver (not illustrated), and this voltage driver generates and transfers driving voltages to the gate driver 135, the data driver 133, and the display panel 137. That is, the voltage driver receives a commercial power, i.e., an alternate voltage of 110V or 220V, from an outside, and generates and provides a supply voltage VDD that is required for the display panel 137, or provides a ground voltage VSS. Further, the voltage driver may generate and provide a gate on voltage Vgh to the gate driver 135. For this, the voltage driver may include a plurality of voltage driving modules (not illustrated) that individually operate.

A plurality of gate lines GL1 to GLn and data lines DL1 to DLn, which cross each other to define a pixel region, may be formed on the display panel 137, and RGB light emitting diodes, such as OLEDs, may be formed in the pixel region. Further, switching devices, i.e., TFTs, are formed on parts of the pixel region, and more particularly, on the corners of the pixel region. When the TFTs are turned on, grayscale voltages are provided from the data driver 133 to the RGB light emitting diodes. In this case, the RGB light emitting diodes provide light corresponding to an amount of current provided on the basis of the grayscale voltages. That is, as a larger amount of current is provided, the RGB light emitting diodes provide a larger quantity of light to that extent.

Although explanation has been made around the OLEDs in the above-described embodiment, the outputter 130 may be implemented by various display technologies, such as an LCD (Liquid Crystal Display) panel, a PDP (Plasma Display Panel), a VFD (Vacuum Fluorescent Display), an FED (Field Emission Display), and an ELD (Electro Luminescence Display).

In the case where the display apparatus 100-2 is in the standby power mode, the controller 160 may operate to supply the charged power to at least one of the A/V decoder 121, the scaler 123, the frame rate converter 125, the video enhancer and the timing controller 131, the data driver 133, the gate driver 135, and the display panel 137.

The main power unit 170 is a constituent element that supplies a main power to the constituent elements of the display apparatus 100-2, and supplies a DC power that is input from an external adapter. The main power unit 170 may be an SMPS (Switched Mode Power Supply). The SMPS is a module type power supply that converts an AC power that is supplied from a commercial power source to match the display apparatus 100-2. The SMPS obtains various kinds of stable DC voltages through switching control using a high frequency using high-speed power semiconductor and rectifying and smoothing circuits.

If the power stored in the charger 150 is lower than a predetermined value in the case where the display apparatus 100-2 is in the standby power mode, the controller 160 may control the main power unit 170 to supply the power to the constituent elements of the display apparatus 100-2. That is, if the charged power is not sufficient, the power is supplied from the main power unit.

Further, as illustrated in FIG. 4, the charger 150 may include a plurality of batteries (battery 1 to battery n). Further, the generator 140 may include a plurality of thermoelectric generators (thermoelectric generator 1 to thermoelectric generator n). In this case, the respective thermoelectric generator may charge the respective batteries (battery 1 to battery n) through conversion of heat that is generated in the display apparatus 100-2 into electricity.

Further, although not illustrated in the drawing, the display apparatus 100-2 may further include a storage (not illustrated).

The storage may store therein the operating system, application programs, and data. In particular, the storage may store therein a program for executing a display method which includes receiving video data, processing the received video data, outputting the processed video data, generating a power using heat that is discharged from a display apparatus, charging the generated power, and supplying the charged power to constituent elements of the display apparatus in the case where the display apparatus is in a standby power mode.

The storage may be implemented by various kinds of technical means. For example, the storage may include a memory, such as a ROM or a RAM, a HDD (Hard Disk Drive), and a BD (Blu-ray Disk). As the memory, a nonvolatile memory, such as an EEPROM (Electrically Erasable and Programmable ROM) or a nonvolatile RAM, may be used. However, the use of a volatile memory, such as a static RAM or a dynamic RAM, is not excluded.

Hereinafter, a display method according to various embodiments of the present disclosure will be described with reference to the accompanying drawings.

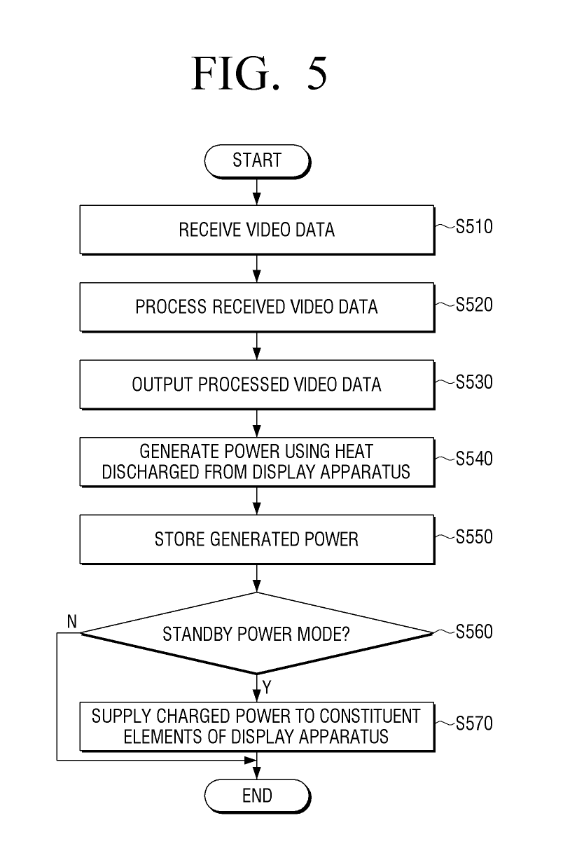

FIG. 5 is a flowchart of a display method according to an embodiment of the present disclosure.

Referring to FIG. 5, a display method according to an embodiment of the present disclosure includes receiving video data (S510), processing the received video data (S520), outputting the processed video data (S530), generating power using heat that is discharged from a display apparatus (S540), storing the generated power (S550), and supplying the stored power to constituent elements of the display apparatus (S570) in the case where the display apparatus is in a standby power mode (S560-Y).

In this case, the supplying the stored power may include supplying the stored power to the constituent elements of the display apparatus if the stored power is equal to or higher than a predetermined value in the case where the display apparatus is in the standby power mode.

Further, the supplying the stored power may include supplying the stored power to a RTC (Real Time Clock) unit if the stored power is equal to or higher than the predetermined value in the case where the display apparatus is in the standby power mode.

Further, the supplying the stored power may include supplying the stored power to at least one of a receiver, a signal processor, and an outputter if the stored power is equal to or higher than a predetermined value in the case where the display apparatus is in the standby power mode.

In this case, the display apparatus may enter into the standby power mode if a predetermined time elapses in a state where the video data is not input.

Further, the display apparatus may enter into the standby power mode if a predetermined control signal is received from a remote control device.

Further, the display method may further include a main power unit supplying the power to the constituent elements of the display apparatus if the charged power is lower than a predetermined value in the case where the display apparatus is in the standby power mode.

Further, the supplying the charged power may supply the charged power to at least one of an A/V decoder, a scaler, a frame rate converter, a video enhancer, and a timing controller in the case where the display apparatus is in the standby power mode.

Further, the generating the power may generate the power using a thermoelectric generator.

The display method of the display apparatus according to various exemplary embodiments described above may be implemented in a program so as to be provided to the display apparatus. Particularly, the program including the display method of the display apparatus may be stored and provided in a non-transitory computer readable medium.

The non-transitory computer readable medium does not mean a medium storing data for a short period such as a register, a cash, a memory, or the like, but means a machine-readable medium semi-permanently storing the data. Specifically, various applications or programs described above may be stored and provided in the non-transitory computer readable medium such as a compact disc (CD), a digital versatile disk (DVD), a hard disk, a Blu-ray disk, a universal serial bus (USB), a memory card, a read-only memory (ROM), or the like.

Hereinabove, although the exemplary embodiments of the present disclosure have been shown and described, it should be understood that the present disclosure is not limited to the disclosed embodiments and may be variously changed by those skilled in the art without departing from the spirit and the scope of the present disclosure. Therefore, the present disclosure should be construed as including all the changes, equivalents, and substitutions included in the spirit and scope of the present disclosure.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

What is claimed is:

1. A display apparatus, comprising:
a receiver configured to receive video data;
a signal processor configured to process received video data;
an outputter configured to output processed video data;
a generator configured to generate power using heat that is discharged from the display apparatus;
a charger configured to store generated power; and
a controller configured to control supplying of stored power to constituent elements of the display apparatus when the display apparatus is in a standby power mode.

2. The display apparatus as claimed in claim 1, wherein the controller operates to supply the stored power to the constituent elements of the display apparatus when the power stored in the charger is equal to or higher than a predetermined value when the display apparatus is in the standby power mode.

3. The display apparatus as claimed in claim 2, wherein the controller operates to supply the stored power to a RTC (Real Time Clock) unit when the power stored in the charger is equal to or higher than the predetermined value when the display apparatus is in the standby power mode.

4. The display apparatus as claimed in claim 1, wherein the controller operates to supply the stored power to at least one of the receiver, the signal processor, and the outputter when the power stored in the charger is equal to or higher than a predetermined value when the display apparatus is in the standby power mode.

5. The display apparatus as claimed in claim 1, wherein the display apparatus enters into the standby power mode when a predetermined time elapses when the video data is not input.

6. The display apparatus as claimed in claim 1, wherein the display apparatus enters into the standby power mode when a predetermined control signal is received from a remote control device.

7. The display apparatus as claimed in claim 1, wherein the controller controls a switched mode power supply unit to supply the power to the constituent elements of the display apparatus when the power stored in the charger is lower than a predetermined value when the display apparatus is in the standby power mode.

8. The display apparatus as claimed in claim 1, wherein the signal processor includes at least one of an audio/video (A/V) decoder, a scaler, a frame rate converter, and a video enhancer,
the outputter includes a timing controller, and
the controller operates to supply the stored power to at least one of the A/V decoder, the scaler, the frame rate converter, the video enhancer, and the timing controller when the display apparatus is in the standby power mode.

9. The display apparatus as claimed in claim 1, wherein the generator comprises a thermoelectric generator.

10. A display method, comprising:
receiving video data;
processing received video data;
outputting processed video data;
generating power using heat that is discharged from a display apparatus;
storing generated power; and
supplying stored power to constituent elements of the display apparatus when the display apparatus is in a standby power mode.

11. The display method as claimed in claim 10, wherein the supplying the stored power supplies the stored power to the constituent elements of the display apparatus when the stored power is equal to or higher than a predetermined value in the case when the display apparatus is in the standby power mode.

12. The display method as claimed in claim 11, wherein the supplying the stored power supplies the stored power to a RTC (Real Time Clock) unit when the stored power is equal to or higher than the predetermined value when the display apparatus is in the standby power mode.

13. The display method as claimed in claim 10, wherein the supplying the stored power supplies the stored power to at least one of a receiver, a signal processor, and an outputter when the stored power is equal to or higher than a predetermined value when where the display apparatus is in the standby power mode.

14. The display method as claimed in claim 10, wherein the display apparatus enters into the standby power mode when a predetermined time elapses in a state where the video data is not input or when a predetermined control signal is received from a remote control device.

15. The display method as claimed in claim 10, further comprising a main power unit supplying the power to the constituent elements of the display apparatus when the stored power is lower than a predetermined value when the display apparatus is in the standby power mode.

16. The display method as claimed in claim 10, wherein the supplying the stored power supplies the stored power to at least one of an audio/video decoder, a scaler, a frame rate converter, a video enhancer, and a timing controller in the case when the display apparatus is in the standby power mode.

17. The display method as claimed in claim 10, wherein the generating the power generates the power using a thermoelectric generator.

18. A display apparatus, comprising:
a display element that produces heat;
a converter configured to convert the heat to electricity;
a storage configured to store the electricity; and
a controller configured to power the display element with electricity from the storage when the display element is in a standby state.

19. The display apparatus of claim 18, wherein the converter comprises a thermocouple.

20. A display method, comprising:
producing heat by a display element;
generating electricity using the heat;
storing the electricity; and
supplying stored electricity to the element when the display element is in a standby state.
